(19) United States
(12) Patent Application Publication
(10) Pub. No.: US 2003/0015145 A1
(43) Pub. Date: Jan. 23, 2003

(54) Method for producing odor and moisture absorbing pad for animals using protective containerboard

(76) Inventor: Dennis Deg, Lodi, CA (US)

Correspondence Address: Dennis Deg, 1744 Windjammer Court, Lodi, CA, 95242, US

(21) Appl. No.: 09/908,123

(22) Filed: Jul. 17, 2001

(51) Int. Cl. A01K 29/00

(52) U.S. Cl. 119/169

(57) ABSTRACT

A thin disposable odor and moisture absorbing pad comprised of a cellulose fiber material impregnated with carbon for use in maintaining a clean and healthy environment in cages and other containers in which animals are housed.

### CROSS-REFERENCE TO RELATED APPLICATIONS

Not applicable

### BACKGROUND OF INVENTION

1. Field of the Invention

This invention relates in general to a disposable pad for reptiles or other animals, which are contained in cages or other enclosures or use an enclosed container for depositing feces and urine, specifically to such pads that are odor absorbing and liquid absorbing.

2. Description of Prior Art

One of the major problems associated with keeping any animal in captivity is odor control of the urine and solid excrement of the animals. Another problem is the time it takes to clean the cage or container. If the animal is being kept for commercial reason, the faster and less often the cage or container needs to be cleaned to control the odor the lower will be the production cost. If the animal is being kept for personal pleasure, the more convenient the task of odor control can be made the better the environment will be for the animal and the owner.

Various methods have been tried in the past to control the urine and excrement waste and subsequent odors. For example, newspaper, excelsior, sponge rubber, artificial turf, and cat liter have been spread over the bottom of the cages or containers, all have certain disadvantages.

Excelsior and pine wood shavings have often been used on the bottom of the cages. They are more flammable than desired, small pieces may be accidentally ingested by the animal. The pine oil can cause problems on the animals skin and they are not very absorbent allowing much of the urine to travel to the bottom of the container. The independent structure of the shavings makes them difficult to contain.

Newspaper, which becomes wet, may stick to the bottom of the container and tears easily. Pads made out of sponge rubber, artificial turf or other reusable materials need to be removed and washed and dried. This adds to the clean-up time.

Cat litter, which is used in cat litter boxes and some cages, is produced from rocks found in the ground. Many are not very effective at absorbing substantial quantities of liquid such as urine. As a result, the urine often times settles and remains at the bottom of the litter box.

Many manufacturers of cat litter have attempted to incorporate perfume masking agents in the litter. These scents emit an odor, which is designed to exceed those emanated by any of the offensive odors of the animal. None of the above mentioned methods are designed to absorb the odor.

U.S. Pat. No. 5,819,688 to Walker (1998) discloses a pad made from an odor absorbing and liquid absorbing material mixed with wood fibers. The pad is described in appearance as looking like the texture of the back of an acoustic ceiling tile. The pad is further described as having a somewhat firm fiber surface. It is preferably about one-fourth of an inch in thickness, but could be made in a range from one-eighth to about one-half inch. This construction and thickness would make the pad difficult for the user to trim or cut to fit if necessary. Pads with these thicknesses would consume large amounts of storage space if a large number of pads where required to service a large animal population. This construction would make it more difficult and expensive to produce than the present invention.

U.S. Pat. No. 4,832,228 to Hickey (1989) discloses a disposable poultry tray liner made of multiple plys of papers but does not address the problem of odor control.

### SUMMARY

In accordance with the present invention a disposable, inexpensive, lightweight, odor controlling and liquid absorbing animal pad.

### OBJECTS AND ADVANTAGES

Thus, with the known disadvantages of prior art, the present invention was developed to assist with the objectives of providing an inexpensive, lightweight, disposable and odor controlling pad. Accordingly, several objects and advantages of the present invention are:

(a) to provide a pad which can be produced from an inexpensive material, at a high rate of speed in order to keep the production cost relatively low, encouraging disposability;

(b) to provide a pad which will be lightweight in order to not consume large amounts of storage space and may be easily cut or shaped to fit any container, and also may fold easily for quick clean-up and removal from the container;

(c) to provide a pad which would be odor absorbing;

(d) to provide a pad which would be liquid absorbing; and

(e) to provide a pad which would be easily disposable.

Further objects and advantages of the present invention will become apparent from a consideration of the drawings and ensuing description.

### BRIEF DESCRIPTION OF THE DRAWINGS

FIG. 1 demonstrates a typical animal or reptile container in a partial cut-away view demonstrating and exposing the pad placed therein;

FIG. 2 shows an enlarged end view of the pad as seen in FIG. 1.

FIG. 3 shows an enlarged end view of a pad with an embossed pattern on the surface

FIG. 4 shows the pad in a rolled form

### REFERENCE NUMERALS IN DRAWINGS

10 Animal container

12 Pad

### DESCRIPTION OF THE PREFERRED EMBODIMENT

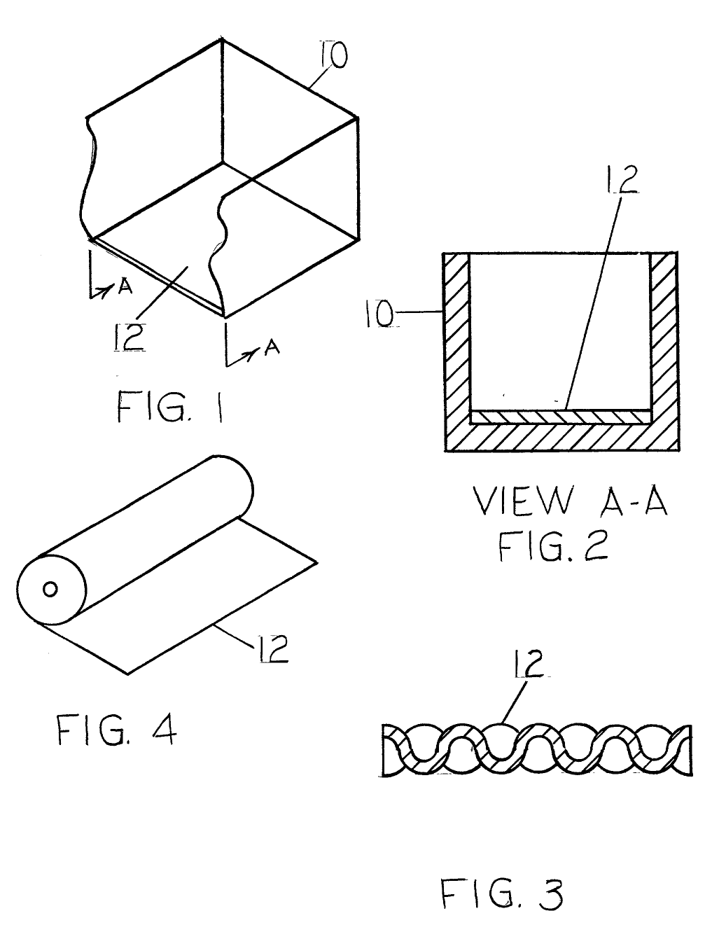

In the embodiment as illustrated in FIG. 1, the present invention is generally rectangular in shape although it may adapt essentially any shape or size to conform to the environment in which it would be used. It is placed on the bottom of the animal container, under it if the animal container has a wire bottom, or under the litter if used in a litter box. In these position the pad can receive and collect the discharges from the animal and the odors arising from those discharges.

The preferred form of the pad is comprised of a carbon impregnated recycled cellulose material. The material is approximately 0.013 (thirteen thousandths) of an inch in thickness. This carbon impregnated material is made on a cylinder type paper making machine. This allows the carbon impregnated paper to be made in layers. It is manufactured with a buried layer of carbon in the middle and an acrylic wax coating on one side.

The two sides of the pad look different. The waxed side has a glossy appearance. The pad will perform best if the waxed side is placed down away from the animal. This allows the side with no wax coating to quickly absorb any liquid coming into contact with the pad. The impregnated carbon absorbs the odor from the discharge of the animal, and the wax coating prevents the liquid from migrating through the pad, this holds the majority of the liquid in the fibers of the pad until the pad can be replaced.

### ALTERNATIVE EMBODIMENTS

There are various possibilities with regard to shape and finish of the pad. For commercial applications where the animals are kept in long rows of cages with catch containers underneath, the pad material would be made in a roll form, as shown in FIG. 4, instead of a cut to size rectangle.

FIG. 3 shows an enlarged end view of a pad with an embossed surface. Passing the pad material between two mated male and female rollers produces this embossed surface. The embossed surface being rougher allows a retile to move more easily across the surface without slipping.

### DETAILED DESCRIPTION OF THE DRAWINGS AND OPERATION OF THE INVENTION

Referring now in more detail and by reference characters to the drawings FIG. 1 shows a typical animal container 10. Some are made from clear plastic or glass and some are made from wire. These types are used for easy viewing of the animal inside. On the bottom of container 10 is placed pad 12 consisting of layered embedded carbon paper.

FIG. 2 shows an enlarged end view of the container 10 and the placement of pad 12 on the bottom of the container 10. The animal lives and moves around on the top surface of pad 12.

FIG. 3 shows an enlarged end view of pad 12 with an embossed surface. The embossed surface makes it easier for reptiles and some other animals to maneuver by providing some roughness to the surface of pad 12. Embossing also increases the amount of fiber and carbon per square inch of surface area, thereby allowing for an increased amount of absorption.

FIG. 4 shows a rolled version of pad 12. Some commercially kept animals are contained in long rows of container 10 with wire bottoms with catch trays below the wire bottoms. The wire bottoms of container 10 allow the urine and excrement to fall through the wire bottom of container 10 on to the surface of pad 12. Pad 12, in roll form, allows for quick application of pad 12 to these long rows of catch trays.

### CONCLUSION, RAMIFICATIONS, And SCOPE Of INVENTION

Thus the reader will see that the pad of the present invention provides an economical, lightweight odor and liquid absorbing pad for use with caged or contained animals.

From the description above, a number of advantages of the light weight odor absorbing animal pad become evident:

(a) The pad allows for storage of many pads in a relatively small area.

(b) The pad allows the odor produced from the animal to be absorbed.

(c) The pad can easily be cut or torn to fit any shape of enclosure.

(d) The pad can easily be rolled or folded to contain the excrement for quick easy clean up and disposal.

(e) The pad can be produced at a relatively fast rate of speed making them economical to produce.

While the description above contains many specifications, these should not be construed as limiting the scope of the presently preferred embodiments of this invention. For example, the pad can have other shapes, such as, circular, oval, trapezoidal or die cut to fit a particular enclosure etc. or the pad could be made with different colors. The pad can be produced with different thicknesses of paper up to and including 0.050 (fifty thousandths of an inch).

Accordingly, the scope of the invention should be determined not by the embodiments illustrated, but by the appended claims and their legal equivalents.

I claim:

1. A disposable odor and moisture absorbing pad for use where unwanted odor and moisture from animal urine and excrement will come in contact with or be in close proximity thereto, said pad comprising:
(a) a cellulose fiber material; and
(b) said cellulose fiber material being impregnated with an odor absorbing material.

2. The odor and moisture absorbing pad of claim 1 is further characterized in that the cellulose fiber material is approximately 0.013 inches in caliper thickness.

3. The odor and moisture absorbing pad of claim 2 is further characterized in that the cellulose material is capable of absorbing the liquid discharge from the animal.

4. The odor and moisture absorbing pad of claim 1 is further characterized in that the odor absorbing material is carbon.
